(19) United States
(12) Patent Application Publication
(10) Pub. No.: US 2011/0106364 A1
(43) Pub. Date: May 5, 2011

(54) Device for speed control and distance control in motor vehicles

(76) Inventors: Goetz Braeuchle, Reichartshausen (DE); Hermann Winner, Bietigheim (DE)

(21) Appl. No.: 10/553,166

(22) PCT Filed: Mar. 3, 2004
(86) PCT No.: PCT/DE04/00404

§ 371 Date: Jul. 23, 2008

(30) Foreign Application Priority Data
Apr. 30, 2003 (DE) 103 19 337.5

(51) Int. Cl. B60K 31/00

(52) U.S. Cl. 701/29

(57) ABSTRACT

A device for speed control and distance control in motor vehicles is provided, the device having a location system for locating objects in the near field of the vehicle, a controller and a selecting device for selecting a located object as the target object for the distance control, and the device also having a slow-travel function that is usable only below a limit speed, in which the selecting device classifies a broadened class of objects as possible obstacles. The device for speed control and distance control also includes a detecting device for detecting a sequential traffic operation, in which a preceding vehicle is followed as target object, and a determining device for determining the limit speed as a function of the operating state detected by the detecting device.

### FIELD OF THE INVENTION

The present invention relates to a device for speed control and distance control in motor vehicles, the device having a location system for locating objects in the near field of the vehicle, a controller and a selecting device for selecting a located object as the target object for the distance control, and having a slow-travel function that is usable only below a limit speed, in which the selecting device classifies a broadened class of objects as possible obstacles.

### BACKGROUND INFORMATION

The devices of above type are also designated as adaptive speed control systems or ACC systems (adaptive cruise control), and make it possible, for instance, during travel on expressways, to adjust the speed of the vehicle in such a way that, in sequential operation, a preceding vehicle is followed at a safe distance. On the other hand, in clear-lane operation, that is, when no preceding vehicle is located in one's own lane, control to a desired speed selected by the driver takes place. For safety reasons, this ACC function is available only above a certain minimum speed, and is provided for traffic situations in which normally one need not expect standing obstacles in the traffic lane. Therefore, only mobile targets come into consideration as target objects for distance control, whereas standing targets at the edge of the lane are ignored.

Devices of the type mentioned at the outset are described in published German patent documents DE 198 33 645 and DE 199 58 520, and as the slow-travel function they have, for example, a so-called stop & roll or stop & go function. Using the stop & roll function, it is possible to automatically brake the vehicle to a standstill, for instance, when one is driving up to the end of a traffic jam. In addition to this, the stop & go function also makes possible automatically driving off again, and may be used even in dynamic traffic situations, such as in city traffic, if there is sufficient reliability of the locating system and the selecting device.

In these slow-travel functions, non-moving objects, such as vehicles standing in the lane, also have to be taken into consideration. One difficulty is to fix the criteria for the selection of relevant objects in the selecting device in such a way that, on the one hand, collisions with obstacles may be reliably avoided, and, on the other hand, that non-genuine obstacles at the edge of the lane do not lead to faulty reactions. For the selection of target objects, usually a travel route envelope is defined, whose width and course correspond as accurately as possible to the traffic lane in which one's own vehicle is traveling. If the travel route envelope is selected to be too tight, there is the danger that obstacles, such as vehicles half standing in the traffic lane, are not appropriately considered. However, with increasing width of the travel route envelope, there is an increase in the danger of erroneous braking, which is not foreseeable by the following traffic, and which thereby represents an accident risk on its part. As travel speed increases, the separation distance range within which standing objects have to be taken into consideration as possible obstacles also becomes greater. Since, as a consequence, the danger of faulty reactions becomes greater with increasing speed, and the consequence of such faulty reactions also become more grave, the slow-travel function is usable only below a certain limit speed. Once the driver has activated the slow-travel function, the speed of the vehicle, and also the desired speed selectable by the driver, are automatically limited to the limit speed. If the driver wishes to have a higher speed, he has to deactivate the slow-travel function or switch over to the ACC function. If the driver overrides the speed control by operating the accelerator, an automatic switching can also take place, in connection with an optical or acoustical instruction to the driver that the slow-travel function has been deactivated.

### SUMMARY

The present invention offers the advantage that the speed range for the slow-travel function may be broadened without impairing safety. In this context, the present invention utilizes the fact that a secure detection of relevant obstacles in sequential operation, when a preceding vehicle is being followed, is considerably easier to implement than in clear-lane operation. For, if there is doubt as to whether a standing or slowly moving object, at the edge of the lane or close to the edge of the lane, represents a relevant obstacle, the decision is made easier in that the preceding vehicle, that is being followed as target object, on its part reacts to the obstacle or passes this obstacle without danger. Especially in situations in which the target object is being followed at a relatively short distance, in this manner, a high degree of safety may be achieved in obstacle detection, whereas in the case of a great distance from the target object, or in a clear-lane situation, obstacle detection is problematical. For this reason, the device according to the present invention has detecting equipment that distinguishes between sequential traffic operation and clear-lane operation. The differential speed for the slow-travel function is then varied depending on the situation. In the simplest case, this may occur in such a way that in sequential traffic operation a greater limit speed is selected than in clear-lane operation.

If the detection equipment recognizes a change from sequential traffic operation to clear-lane operation, that is, if it detects a loss of the target object, there is an automatic switchover to a lower limit speed. The actual speed of the vehicle, provided it is greater than the lower limit speed, is then reduced only gradually to the new limit speed. For this, one may avail oneself of the functions for controlling deceleration processes that are present in the controller anyway. It may be implemented, however, that the limit speed shall not be abruptly switched over, but that it shall be reduced to a lower limit speed, using a time-controlled or acceleration-controlled slope. In this manner, it may be achieved that the speed adaptation to the new situation takes place at a moderate deceleration, which is not perceived to be uncomfortable by the passengers of the vehicle, and which does not irritate the following traffic. The equivalent is true also for the increase in the limit speed and the acceleration of the vehicle during a change from clear-lane operation to sequential traffic operation, for instance, if a preceding vehicle cuts into the controlled vehicle's lane.

In one specific example embodiment, the limit speed is a function of the distance from the target object within certain upper and lower limits, so that a greater limit speed is allowed if the distance from the preceding vehicle is short. This is of advantage especially if the speed of the preceding vehicle, which, within the scope of the distance control is being followed at a provided setpoint distance, varies about the limit speed. As an example, let us assume that the speed of the preceding vehicle is closely below the currently valid limit speed, and that the distance of this vehicle is equivalent to the setpoint distance, which, on its part, is a function of the speed, and is defined by a specified time gap, that is, by the difference in time at which the two vehicles pass the same point on the traffic lane. Now, if the preceding vehicle decelerates, the distance control reacts with a corresponding deceleration of the controlled vehicle. In this context, the setpoint distance and accordingly also the actual distance go down. Now, if the preceding vehicle is accelerated again, and, in the process, temporarily exceeds the current limit speed, perhaps in order to close up on another preceding vehicle that is farther ahead, the controlled vehicle could no longer follow the preceding vehicle, at unchanging limit speed. If, on the other hand, the limit speed is increased with respect to the lower actual distance, the controlled vehicle may also travel temporarily at an increased speed and maintain the distance from the target object. In this manner, a falling back of one's own controlled vehicle, and the interference in the traffic flow connected with it, is avoided. Only when the preceding vehicle accelerates further, and therewith the setpoint distance and the actual distance become greater again, the limit speed also goes down again, and the function limiting the speed becomes effective when one's own controlled vehicle attains the limit speed.

### BRIEF DESCRIPTION OF THE DRAWINGS

FIG. 1 shows a block diagram of the device according to the present invention.

FIG. 2 shows a graphic representation of the function of the limit speed of the distance from the target object in sequential traffic operation.

FIG. 3 shows a flow chart illustrating an example method of operation of the device.

### DETAILED DESCRIPTION

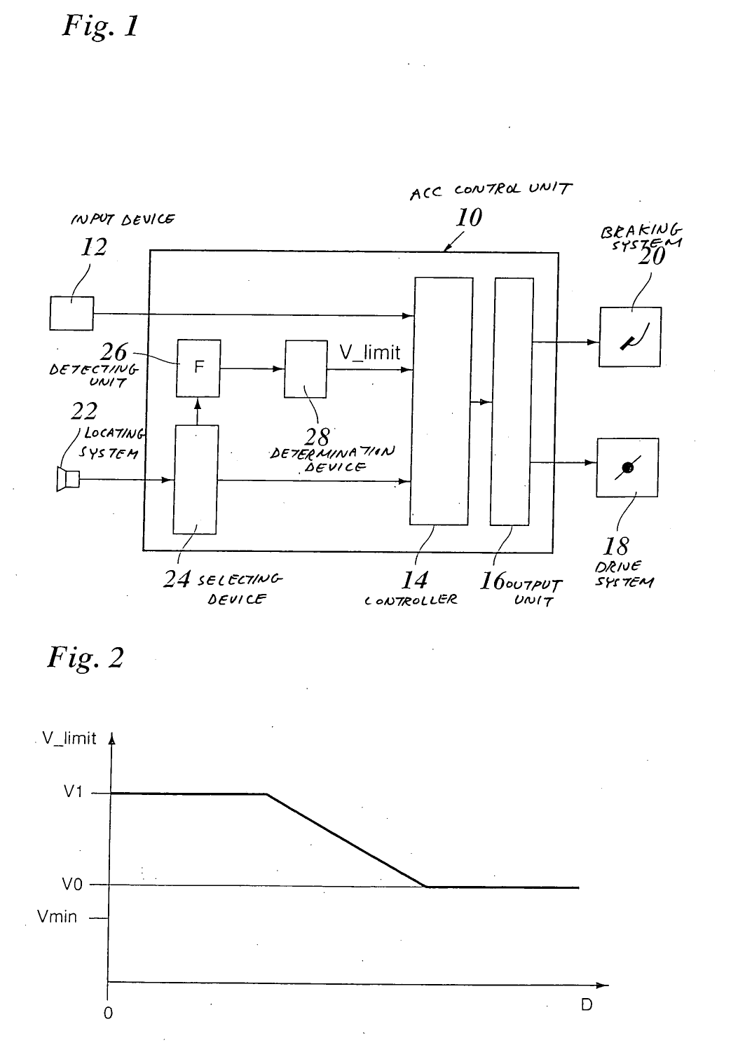

FIG. 1 shows an ACC control unit 10, which forms the core part of a device for distance control and speed control in a motor vehicle, and whose function is carried out, for example, by one or more suitably programmed microprocessors. Via an input device situated on the dashboard or the steering wheel of the vehicle, the driver can input various commands for activating or deactivating various functions of ACC control unit or device 10, e.g., for inputting a desired speed for the speed control in clear-lane operation. A controller 14 compares the desired speed to the actual speed V of the vehicle, which is measured by a speed sensor (not shown), and influences drive system 18 via an output unit 16, and, if necessary, also braking system 20 of the vehicle, so as to regulate the speed to the desired speed.

A locating system 22, for instance, in the form of a radar sensor having angular resolution, locates standing and moving objects in the near field of the vehicle and reports the measured distances, relative speeds and azimuth angle of the located object to a selecting device 24. Standing objects are recognized in that their relative absolute speed agrees with the actual speed V of the controlled vehicle. In an ACC mode, which is only able to be activated above a certain minimum speed Vmin, standing objects are ignored. With the aid of distance data and angular data, selecting device 24 checks for each object whether the object is inside or outside a certain travel route envelope, which represents approximately the course and the width of the traffic lane traveled by one's own vehicle. If at least one moving object is located within the travel route envelope, then this object, and, in the case of several objects, the one located at the least distance, is selected as the target object for the distance control. The distance data and the relative speed data of this target object are transmitted to control 14, which, with the aid of these data, modifies the speed of the vehicle in such a way that the target object is followed, using a certain time gap which may be selected by the driver, within certain limits.

If the speed of the vehicle undershoots minimum speed Vmin, ACC mode is deactivated, and the driver receives an acoustical or optical message to the effect that this function is no longer available. The driver then either has to take control of the vehicle himself or activate a slow-travel function implemented in controller 14, such as a stop & go function, which is also available in the lower speed range all the way to speed 0, and which permits, among other things, braking the vehicle to a standstill, when the preceding vehicle also stops. However, the stop & go function is only available below a certain limit speed V_lim, which is variable within certain limits, as will be explained in more detail below. Minimum speed Vmin for the ACC mode may lie within or below the variation range for limit speed V_lim for the slow-travel function, so that there is a certain overlap range in which both functions are available.

When selecting device 24 has selected a target object for the distance control, a flag F is set to 1 in a detecting unit or device 26. If the target object is lost or if, right from the start, there is no target object present, flag F is set to 0. In this way, detecting unit 26 makes possible a distinction between a sequential traffic operation (F=1) and a clear-lane operation (F=0). This information is used in a determination device 28 for determining the respective limit speed V_lim for the slow-travel function or the stop & go function. This limit speed is transmitted to controller 14, and there it replaces or limits the desired speed selected by the driver, if the slow-travel function is in an activated state. If the actual speed V of the vehicle is above limit speed V_lim, the driver is informed by a suitable indication that the slow-travel function is not able to be activated, or the vehicle is automatically decelerated to V_lim.

In clear-lane operation, limit speed V_lim has a value V0, which forms the lower limit of the variation range for the limit speed, such as 40 km/h. In sequential traffic operation (F=1), on the other hand, limit speed V_lim, according to a monotonically falling function, is a function of distance D from the target object, as is shown in FIG. 2. At short distances D, V_lim has the value V1 at the upper limit of the variation range, such as 50 km/h. At medium distances D, V_lim steadily decreases to the value V0—linearly in the example shown. At even greater distances V_lim remains constant at the value V0. This function curve is based on the consideration that standing or extremely slow objects, which, in slow-travel mode also have to be taken into consideration as possible obstacles, are easier and more surely to be detected as genuine obstacles or to be discarded as irrelevant objects and hence, the shorter the distance to the followed target object. For example, selecting device 24 is designed in such a way that standing objects, whose measured distance is greater than distance D of the target object (of the preceding vehicle) are discarded as being irrelevant. In the same way, standing objects may also be classified as being irrelevant which were just passed by the preceding vehicle. Then, essentially, only those objects remain as standing obstacles which were recorded for the first time by the locating system after the preceding vehicle had passed the location of this object. Examples for this would perhaps be a vehicle suddenly traveling in from a side street, or a suddenly opening driver's door of a parking vehicle. In one refined selecting procedure, it may also be taken into consideration whether the preceding vehicle reacts, using a speed change or a steering maneuver, to the supposed obstacle. The more reliable these criteria are, the shorter the distance D between one's own vehicle and the target object.

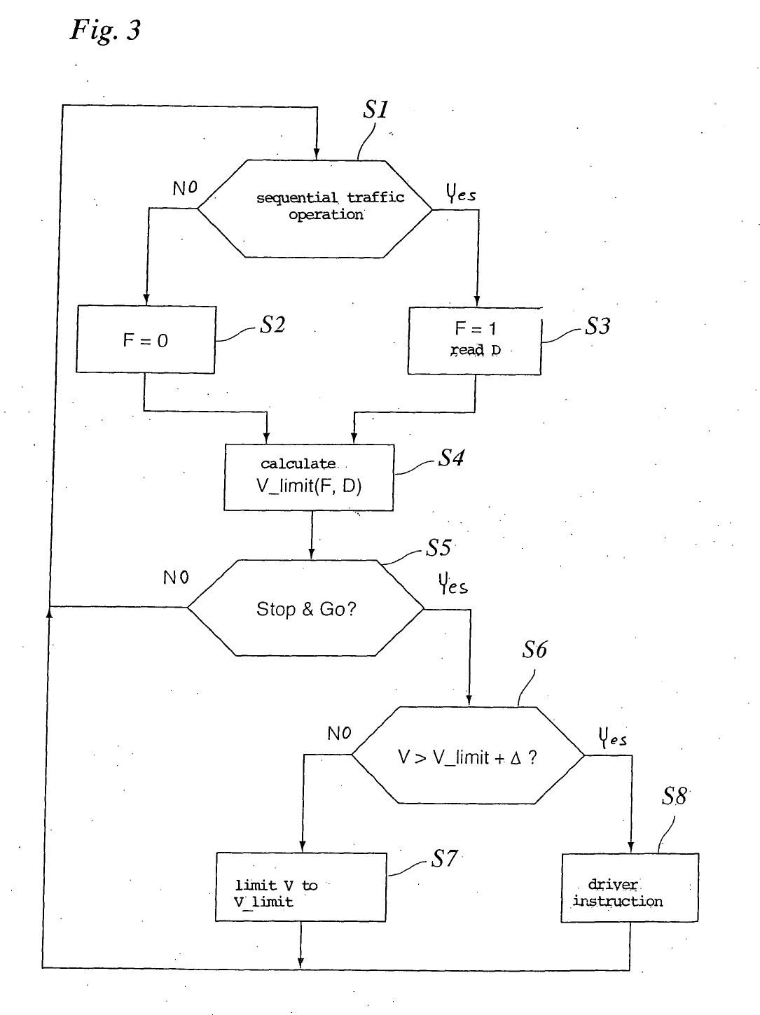

In FIG. 3, the method of operation of the device is explained with the aid of a flow chart.

In step S1, with the aid of the data supplied by selecting device 24, detecting device 26 checks whether sequential traffic operation is taking place or not. If there is no sequential traffic operation, in step S2 flag F is set to 0. Otherwise, in step S3, flag F is set to 1, and measured distance D of the selected target object is read. In both cases there follows, in step S4, the calculation of limit speed V_lim as a function of the state of flag F and of measured distance D, corresponding to the connection shown in FIG. 2, as well as of current value of V_lim (limited change rate). In step S5 it is then checked whether slow-travel function “stop & go” is active. If this is not the case, there is a return to step S1, and the steps described above are cyclically repeated. In response to a positive result of the query in step S5, it is checked in step S6 whether the actual speed V of the vehicle is greater than V_lim plus a certain tolerance interval Δ. If this is not the case, in step S7 the calculated limit speed is transmitted to controller 14. If the desired speed selected by the driver via input device 12 is greater than V_lim, the desired speed is limited to V_lim. In the same way it is prevented that the driver retroactively inputs a greater desired speed than V_lim. Thus it is ensured that the speed of the vehicle does not become greater than V_lim, as long as the slow-travel function is active. Following step S7, there is a return to step S1, and the procedure described above is cyclically repeated.

The case where actual speed V is greater than V_lim+Δ, may, for example, occur if the driver tries to activate the slow-travel function, although the actual speed has not yet decreased below V_lim, or if the driver overrides the speed control using the accelerator. In these cases there follows in step S8 the output of an appropriate instruction to the driver. After that, too, there is a return to step S1. If V_lim is reduced because of the loss of a target object, this reduction takes place in the repeatedly run-through steps S4 so slowly that controller 14 can in each case follow the change (in step 57), and tolerance interval Δ is not departed from.

The desired speed input by the driver via input device 12 may remain stored even when a lower limit speed V_lim is in effect. In response to a transition from clear-lane operation to sequential traffic operation, the limit speed may then be raised to the desired speed originally selected by the driver, but at most to V1.

1-8. (canceled)

9. A device for performing speed control and distance control for a controlled vehicle, comprising:
a locating system for locating objects in the vicinity of the vehicle:
a selecting device connected to the locating system, wherein the selecting device classifies a plurality of objects as possible obstacles, and wherein the selecting device selects a located object as a target object for the distance control;
a detecting device connected to the selecting device and detecting a sequential traffic operation, wherein the sequential traffic operation includes the controlled vehicle following a preceding vehicle as a target object;
a controller connected to the selecting device, wherein the controller implements a slow-travel function only below a threshold limit speed; and
a determining device for determining the threshold limit speed depending on an operating state of the controlled vehicle detected by the detecting device.

10. The device as recited in claim 9, wherein the slow-travel function is an operating mode that makes possible braking the vehicle to a standstill.

11. The device as recited in claim 9, wherein, if the detecting device does not detect a sequential traffic operation, the threshold limit speed in a clear-lane operation has a first determined value, and wherein, if the detecting device detects a sequential traffic operation, the threshold limit speed has a second determined value that is higher than the first determined value.

12. The device as recited in claim 11, wherein, if the detecting device detects a change in the operating state of the controlled vehicle, the determining device changes the threshold limit speed gradually, at a defined rate of change, between the first determined value and the second determined value.

13. The device as recited in claim 11, wherein the threshold limit speed is defined by a monotonically falling function of a measured distance between the controlled vehicle and the target object in the sequential traffic operation.

14. The device as recited in claim 12, wherein the threshold limit speed is defined by a monotonically falling function of a measured distance between the controlled vehicle and the target object in the sequential traffic operation.

15. The device as recited in claim 13, wherein, for a large distance between the controlled vehicle and the target object, the threshold limit speed is reduced to the first determined value for the clear-lane operation.

16. The device as recited in claim 14, wherein, for a large distance between the controlled vehicle and the target object, the threshold limit speed is reduced to the first determined value for the clear-lane operation.

17. The device as recited in claim 9, wherein the selecting device is configured to evaluate objects including stationary objects when the slow-travel function is activated.

18. The device as recited in claim 11, wherein the selecting device is configured to evaluate objects including stationary objects when the slow-travel function is activated.

19. The device as recited in claim 12, wherein the selecting device is configured to evaluate objects including stationary objects when the slow-travel function is activated.

20. The device as recited in claim 13, wherein the selecting device is configured to evaluate objects including stationary objects when the slow-travel function is activated.

21. The device as recited in claim 14, wherein the selecting device is configured to evaluate objects including stationary objects when the slow-travel function is activated.

22. The device as recited in claim 17, wherein, in the sequential traffic operation, in order to determine whether a standing object is a relevant obstacle, the selecting device is configured to evaluate a relationship between a locating data of the standing object and a locating data of the preceding vehicle being followed as the target object.

23. The device as recited in claim 18, wherein, in the sequential traffic operation, in order to determine whether a standing object is a relevant obstacle, the selecting device is configured to evaluate a relationship between a locating data of the standing object and a locating data of the preceding vehicle being followed as the target object.

24. The device as recited in claim 19, wherein, in the sequential traffic operation, in order to determine whether a standing object is a relevant obstacle, the selecting device is configured to evaluate a relationship between a locating data of the standing object and a locating data of the preceding vehicle being followed as the target object.

25. The device as recited in claim 20, wherein, in the sequential traffic operation, in order to determine whether a standing object is a relevant obstacle, the selecting device is configured to evaluate a relationship between a locating data of the standing object and a locating data of the preceding vehicle being followed as the target object.

26. The device as recited in claim 21, wherein, in the sequential traffic operation, in order to determine whether a standing object is a relevant obstacle, the selecting device is configured to evaluate a relationship between a locating data of the standing object and a locating data of the preceding vehicle being followed as the target object.
